(19) United States
(12) Patent Application Publication
(10) Pub. No.: US 2007/0032890 A1
(43) Pub. Date: Feb. 8, 2007

(54) Method and apparatus for robust vibration suppression

(75) Inventors: Li Zhou, Cupertino, CA (US); Eduardo A. Misawa, Stillwater, OK (US)

Correspondence Address: FELLERS SNIDER BLANKENSHIP;BAILEY & TIPPENS, THE KENNEDY BUILDING, 321 SOUTH BOSTON SUITE 800, TULSA, OK, 74103-3318, US

(73) Assignee: The Board of Regents for Oklahoma State University

(21) Appl. No.: 11/385,065

(22) Filed: Mar. 21, 2006

Related U.S. Application Data
(60) Provisional application No. 60/663,796, filed on Mar. 21, 2005.
(60) Provisional application No. 60/663,795, filed on Mar. 21, 2005.
(60) Provisional application No. 60/663,639, filed on Mar. 21, 2005.

(51) Int. Cl. G05B 19/04

(52) U.S. Cl. 700/63; 700/304; 702/113

(57) ABSTRACT

According to a preferred aspect of the instant invention, there is provided a system and method of robust vibration suppression which might be used in many subject matters, but which is preferably used in connection with computer controlled electromechanical devices such as disk drive arms. In a first preferred embodiment, a Gaussian waveform is selected as a velocity profile, with its integral and derivatives providing position and acceleration/jerk profiles respectively. According to another preferred embodiment, the movement velocity profile will be selected to be a member of the prolate spheroid family of waveforms. This family of functions has certain optimal properties with respect to the frequency domain concentration of energy for a given time-domain length time series. The movement of a flexible arm that is performed according to the invention will be one that has minimal or reduced residual vibration after it has reached its destination.

### RELATED APPLICATIONS

This application claims the benefit of U.S. Provisional Patent Application Ser. Nos. 60/663,796, 60/663,639, and 60/663,795 all filed on Mar. 21, 2005, the disclosures of which are incorporated herein by reference as if fully set out at this point. This application is further co-filed and copending with U.S. Patent Application No. ______, the disclosure of which is incorporated by reference.

### STATEMENT REGARDING FEDERALLY SPONSORED RESEARCH

The Government of the United States of America has certain rights in this invention pursuant to Grant No. CMS-9978748 awarded by the National Science Foundation.

### TECHNICAL FIELD

This invention relates to the general subject of suppression of unwanted resonant dynamics in a flexible dynamic system and, as a specific example of an application of the instant invention, suppression of unwanted resonant dynamics in a disk drive arm.

### BACKGROUND OF THE INVENTION

The control of the motion of flexible structures has been a topic of research interest since at least the 1970's, when the control of a flexible manipulator arm was widely studied. Approaches based on modal analysis and closed-loop feedback control of flexible manipulator arm, feedback closed-loop control of flexible manipulator arms with distributed flexibility, etc., were all investigated. However, often the suggested approach was essentially to move slowly to the desired position and then wait for residual vibrations in the arm to cease before, e.g., actually beginning to read from disk. Additionally, feedback and feed forward control methods (the latter being known as “input command shaping”) have both been studied. Input command shaping involves choosing an appropriate shape of the input command for either an open-loop system or closed-loop system so that the system vibrations at the end of the move are reduced. Generally, these techniques include shaped function synthesis, open-loop optimal control, impulse shaping filters, and system-inversion-based motion planning. Note that a great deal of additional information pertaining to the state of the prior art, as well as technical discussion related to the instant invention, may be found in the Ph.D. dissertation “Robust Vibration Suppression Control Profile Generation”, by Li Zhou, May, 2005, Oklahoma State University, the disclosure of which is incorporated by reference into this document as if fully set out at this point.

Of course, and as a specific example, flexible structures such as high-speed disk drive actuators require high precision positioning under tight time constraints. Whenever a fast motion is commanded, residual vibration in the flexible structure is induced, which tends to increase the settling time. One solution is to design a closed-loop control to damp out vibrations caused by the command inputs and disturbances to the plant. However, the resulting closed-loop damping ratio may still be too slow to provide an acceptable settling time. Also, the closed-loop control is not able to compensate for high frequency residual vibration which occurs beyond the closed-loop bandwidth. An alternative approach is to develop an appropriate reference trajectory that can minimize the excitation energy imparted to the system at its natural frequencies. Generally, these techniques include shaped function synthesis, open-loop optimal control, impulse shaping filters, and system-inversion-based motion planning.

One prior art approach that involves shaped function synthesis utilizes a finite Fourier series expansion to construct forcing functions to attenuate the residual dynamic response for slewing a flexible beam. However, the response spectrum envelope is made small only in a limited region. Also the forcing functions are sensitive to the control system. Another prior art approach utilizes a performance index which reflects the concern for the accuracy of the terminal boundary conditions to the changes in mode eigen-frequencies. However, the control inputs are often difficult to calculate, and only a few modes are considered. More recently, an approach has been suggested that utilizes a near minimum-time input with shape control weighting functions. Others have shown that control waveforms can be optimized using a Laplace domain synthesis technique, but the control inputs need to be assumed through a judicious choice.

Those of ordinary skill in the art will recognize that none of the methods discussed above consider all the resonance modes, which in reality may be infinite in number. Also, the modes' responses change drastically due to resonance modeling uncertainty. To overcome the resonance frequency variation, some prior art approaches have utilized a robust vibrationless control solution derived for an enlarged multi-degree-of-freedom system that has some virtual frequencies within the range of the varying natural frequencies. In that same vein, others have sought to utilize a forcing function that comprises a series of ramped sinusoids for one nominal resonance model. In such an approach, the spectrum magnitude of the forcing function becomes small at the nominal resonance frequency and the four additional frequencies surrounding the nominal frequency, but the spectrum magnitude of the forcing function increases significantly at frequencies beyond these.

More recently, a frequency-shaped cost functional whose weighting function is represented by a first order and second-order high-pass filter in the design of vibrationless access control forces has been utilized. The control forces have small frequency components in the high frequency region. But the decay rate in the frequency domain depends on the shape of the weighting function. Other prior art approaches have utilized an access control called SMART (Structural Vibration Minimized Acceleration Trajectory) for hard disk drives. The access formula is derived from the minimum-jerk cost function where the SMART state values (position, velocity, and acceleration) are expressed using time polynomials, but the jerk cost function has no direct relationship to the residual vibration.

Optimal control approaches have also been utilized to generate an input command for a flexible dynamic system. Typically, an objective function is selected and subsequently minimized. For example, with the so-called Bang-Bang Principle, the time-optimal commands must be piecewise constant functions of time and the constants are solely determined by the actuator maximum and minimum power limits. Although it is easy to generate the time-optimal command input for a double integrator system, it is not easy to derive the time-optimal command for a system in which the order is greater than two. Other types of optimal control select different objective functions, for example, integral squared error plus some control penalty. Generally, these objective functions do not explicitly include a direct measure of both the move time and the unwanted resonant dynamics. These profiles are therefore very sensitive to unmodeled flexible dynamics.

The posicast control method uses a kind of set point shaping. This method breaks a step input into two smaller steps, one of which is delayed in time. The delayed input results in a vibration cancellation for a precisely known resonance. So the posicast can reduce the settling time of system response to a step input. As another example, in some instances instead of using two impulses to generate the delayed input, input shapers use three or more impulses to generate a delayed input. The more impulses used, the more robustness is achieved. One of the disadvantages of this technique is that the input shapers induce a delay to the system response. The robustness of the input shapers can cause additional delays to the system response. The more impulses that are used, the more time delay that may be induced. It is also impossible to design an input shaper to accommodate all the resonant modes in a flexible structure

Finally, some prior art approaches have attempted to address the problem of open-loop control of the end-point trajectory of a single-link flexible arm by an inverse dynamic solution. For example, a number of basic sinusoidal time functions and their harmonics have been used in trajectory synthesis. As still another example, some prior art approaches have determined the command function of the system by means of a non-causal system inversion with a continuous derivative of an arbitrary order. Of course, in such an approach a precise model of the system is generally required. Another disadvantage of these system-inversion-based motion planning techniques is that the smooth motion and robustness is achieved at the expense of long move times.

As has been indicated above, although any number of prior art references have considered the problem, there remains no satisfactory solution to the problem of minimizing unwanted resonant dynamics in a flexible dynamic system. Accordingly, it should now be recognized, as was recognized by the present inventors, that there exists, and has existed for some time, a very real need for a method that would address and solve the above-described problems.

Before proceeding to a description of the present invention, however, it should be noted and remembered that the description of the invention which follows, together with the accompanying drawings, should not be construed as limiting the invention to the examples (or preferred embodiments) shown and described. This is so because those skilled in the art to which the invention pertains will be able to devise other forms of this invention within the ambit of the appended claims.

### SUMMARY OF THE INVENTION

According to a preferred aspect of the instant invention, there is provided a system and method of robust vibration suppression which might be used in many subject matters, but which is preferably used in connection with disk drive arms. In a preferred embodiment, a Gaussian waveform is selected as a velocity profile, with its integral and derivatives providing position and acceleration/jerk profiles respectively. This functional form of choice is near optimal in some sense because both the time and frequency domain expressions of a Gaussian curve can be truncated relatively near to the origin without sacrificing too much information. This means that the Gaussian curve has useful properties as a low-pass filter while simultaneously having a relatively short time-domain expression. Said another way, the time/frequency energy localization of the Gaussian curve means that both the velocity profile and its Fourier transform can be made relatively short. Given the preferred Gaussian functional form, the instant invention continues by calculating a parameter of a particular Gaussian-shaped velocity profile, and preferably an acceleration/deceleration profile, that is suited to a particular disk drive arm, or other flexible dynamic system.

According to another preferred aspect of the instant invention, the movement velocity profile will be selected to be a member of the prolate spheroid family of waveforms. This family of functions has certain optimal properties with respect to the frequency domain concentration of energy for a given time-domain length time series. As a consequence, the movement of a flexible arm that is performed according to this sort of function will be one that has minimal or reduced residual vibration after it has reached its destination.

The foregoing has outlined in broad terms the more important features of the invention disclosed herein so that the detailed description that follows may be more clearly understood, and so that the contribution of the instant inventors to the art may be better appreciated. The instant invention is not to be limited, in its application, to the details of the construction and to the arrangements of the components set forth in the following description or illustrated in the drawings. Rather, the invention is capable of other embodiments and of being practiced and carried out in various other ways not specifically enumerated herein. Finally, it should be understood that the phraseology and terminology employed herein are for the purpose of description and should not be regarded as limiting, unless the specification specifically so limits the invention.

### BRIEF DESCRIPTION OF THE DRAWINGS

Other objects and advantages of the invention will become apparent upon reading the following detailed description and upon reference to the drawings in which:

FIG. 1 illustrates the general environment of the instant invention in the context of a computer disk drive.

FIG. 2 is a functional diagram of a typical disk drive.

FIG. 3 illustrates a typical flexible mechanical system.

FIG. 4 illustrates the Bode magnitude plot of a reduced order transfer function R(s).

FIG. 5 illustrates a typical trajectory for a double integrator system.

FIG. 6 illustrates the move time and settle time for a hard disk drive arm movement with open-loop control.

FIG. 7 illustrates the move time and settle time of a closed-loop control.

FIG. 8 illustrates robust vibration suppression position reference generation from a robust vibration suppression velocity profile.

FIG. 9 illustrates a time-optimal command input and its spectrum magnitude.

FIG. 10 illustrates an ideal low-pass filter function and its Fourier transform.

FIG. 11 illustrates the φ(t) and g(t) (shifted time-limited version of φ(t)).

FIG. 12 illustrates waveforms of φ(5,t) and its spectrum magnitude

FIG. 13 illustrates the change of 1−J (log scale) with n.

FIG. 14 illustrates the current control input signal for 5 msec move.

FIG. 15 illustrates the jerk signal for 5 msec move.

FIG. 16 illustrates the position signal for 5 msec move.

FIG. 17 illustrates the position error signal for 5 msec move.

FIG. 18 illustrates reference velocity signal for 5 msec move.

FIG. 19 illustrates the frequency response of the Finite Response Filter (i.e. reference velocity signal) for 5 msec move.

FIG. 20 illustrates a standard closed-loop control scheme.

FIG. 21 illustrates a model reference closed-loop control scheme.

FIG. 22 illustrates a robust forcing function generation from a robust velocity reference signal.

FIG. 23 illustrates implementation of model reference closed-loop control with robust vibration suppression control profiles.

FIG. 24 illustrates discrete prolate spheroidal sequences for the time duration 1.5×10⁻³ sec.

FIG. 25 illustrates a robust vibration suppression velocity profile from discrete prolate spheroidal sequence vₒ[k] with the move time 1.5×10⁻³ sec.

FIG. 26 contains an operating logic typical of one aspect of the instant invention.

### DETAILED DESCRIPTION

While this invention is susceptible of being embodied in many different forms, there is shown in the drawings, and will herein be described hereinafter in detail, some specific embodiments of the instant invention. It should be understood, however, that the present disclosure is to be considered an exemplification of the principles of the invention and is not intended to limit the invention to the specific embodiments or algorithms so described.

### GENERAL ENVIRONMENT OF THE INVENTION

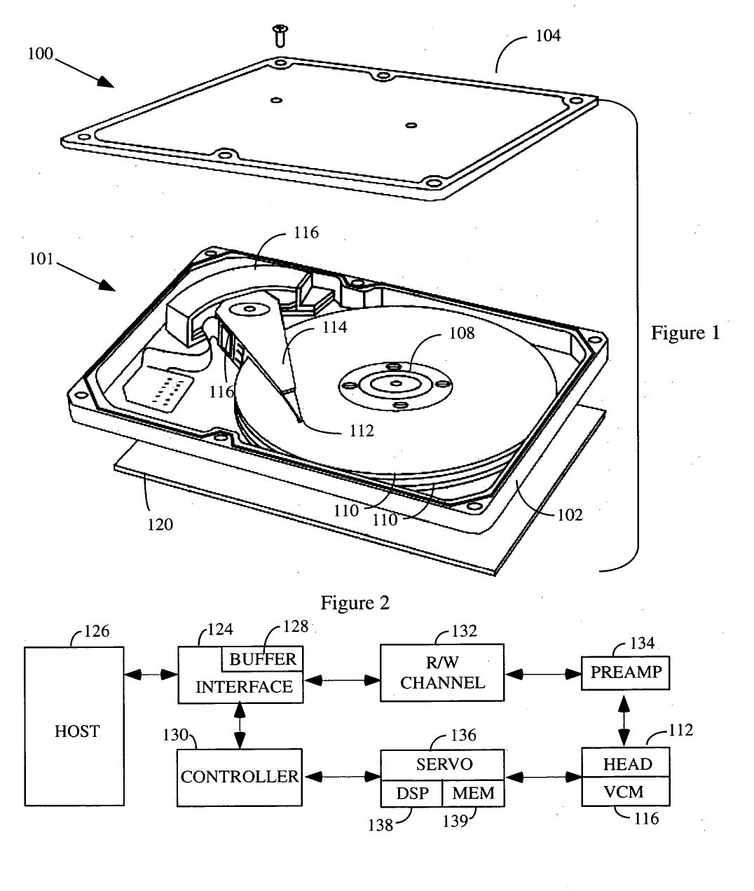

To illustrate an exemplary environment in which presently preferred embodiments of the present invention can be advantageously practiced in the context of computer disk drives, FIG. 1 shows an exploded view of a data storage device 100. The device 100 is preferably characterized as a small form factor disc drive used to store and retrieve user data in a battery-operated, handheld mobile product such as a notebook computer or a digital camera, but such is not limiting to the scope of the claimed subject matter.

The device 100 includes a rigid, environmentally controlled housing 101 formed from a base deck 102 and a top cover 104. A spindle motor 108 is mounted within the housing 101 to rotate a number of data storage media 110 (in this case, two) at a relatively high speed.

Data are stored on the media 110 in an array of concentric tracks (not shown), having a nominal radial density of about 100K tracks/inch (in). The tracks are accessed by a corresponding array of data transducing heads 112 (transducers). The heads 112 are supported by an actuator 114 and moved across the media surfaces by application of current to a voice coil motor, VCM 116. A flex circuit assembly 118 facilitates communication between the actuator 114 and control circuitry on an externally mounted printed circuit board, PCB 120.

As shown in FIG. 2, the control circuitry preferably includes an interface circuit 124 which communicates with a host device 126 using a suitable interface protocol (fibre channel, SAS, SCSI, etc.). The interface circuit 124 includes a buffer (cache memory) 128 for the temporary storage of data being transferred to or from the media 110. A controller 130 provides top level control for the device 100 and is preferably characterized as a programmable, general purpose processor with suitable programming to direct the operation of the device 100.

A read/write channel 132 encodes data to be written to the media 110 during a write operation and reconstructs transduced readback signals from the media 110 to reconstruct previously stored data during a read operation. A preamplifier/driver circuit (preamp) 134 provides head selection circuitry and conditions signals provided to and received from the heads 112.

A servo circuit 136 provides closed loop positional control for the heads 112. The servo circuit 136 preferably includes a digital signal processor (DSP) 138 which operates in accordance with associated programming and data in memory (MEM) 139 and in response to control inputs from the top level controller 130. A two processor system is preferred, but not required.

During a seek operation, the servo circuit 136 moves a selected head 112 from an initial track to a destination track on the associated media surface. Generally, the seek operation is not concluded until the head has successfully settled onto the destination track and the servo circuit is able to follow that track to allow the initiation of data access operations therewith.

It is desirable to carry out seeks in a minimum amount of time in order to maximize overall data throughput rates with the host 126. However, system resonances can adversely impact seek times, since the undesired excitation of such resonances during the movement of the actuator 114 can lengthen the settling time as the head 112 oscillates about the destination track.

### Discussion of the Preferred Embodiments

Turning now to a discussion of the instant invention, as an initial matter it should be noted that the broad design goals of the inventors with respect to velocity/location profiles are generally as follows. First, the velocity/location profile should be transient, which means for purposes of the instant invention that both the start and end of the input velocity profile will preferably have a rapid decay. Second, it is preferred that arbitrary higher order derivatives of the input are assumed to have a rapid decay at the start and end of the movement time period. Third, the energy distribution of the profile should be concentrated in the low frequency region of the spectrum, and, further preferably, below the resonance frequency (or frequencies) of the system. Finally, the system input can be viewed as a low-pass filter which also has a rapid decay at the resonance frequencies in the frequency domain. Note that this property is important to the robustness of this method to all the potentially unknown high frequency resonances.

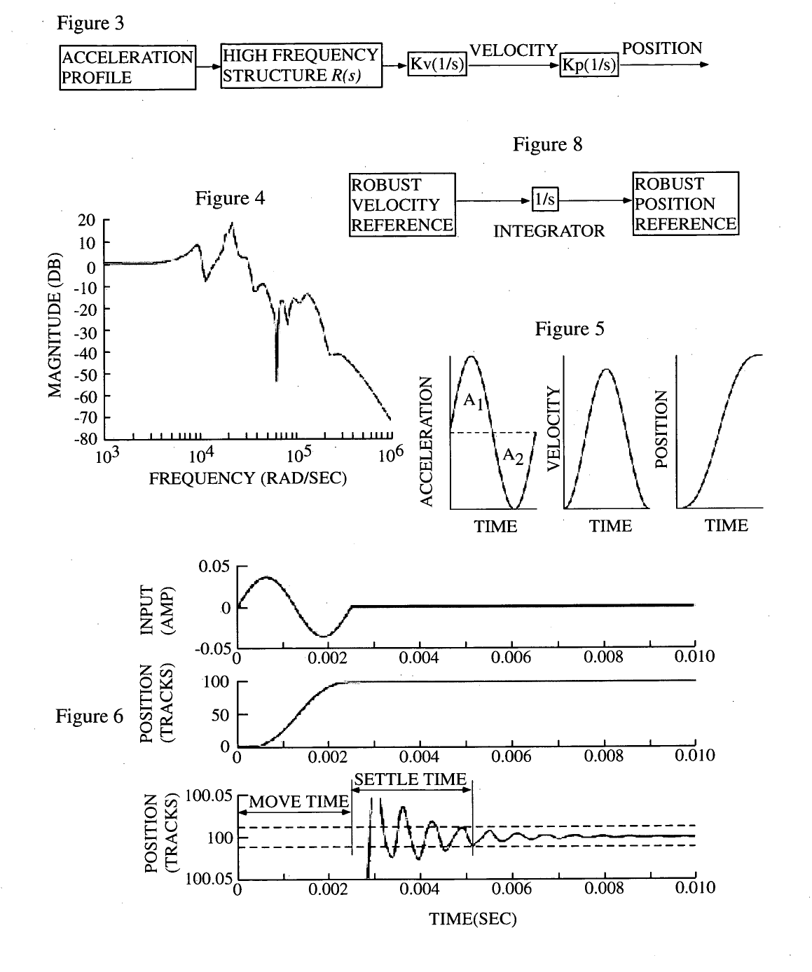

FIG. 3 shows a typical flexible mechanical system level block diagram, where 1/s is an integrator, Kv is a velocity constant gain, and Kp is a position constant gain. The high frequency modes can be described as a transfer function R(s) which has a possibly infinite number of lightly damped resonant structures. FIG. 4 shows a Bode magnitude plot of a typical reduced order (28th order) transfer function R(s). This function was empirically derived from the flexible arm of an open disk drive. As can be readily seen by reference to FIG. 4, the resonance modes change drastically due to variation of the mode parameters. On the Bode plot, the peaks of the frequency response may shift horizontally in frequency and vertically in amplitude.

Note that a primary goal of the instant invention is to find a fast input trajectory, under some physical constraint, that has the least possible residual vibration. To that end, the approach used herein will be to consider the movement of the rigid mode described by the double integrator 1/s², from acceleration to position. For purposes of clarity in the discussion that follows, the constant gains Kv and Kp will not be considered.

A typical trajectory for a double integrator system is shown in FIG. 5. Notice that, in order to secure a zero velocity status of the rigid mode after a move, the area of A₁ should be equal to the area of A₂. Physically, if a finite move time is imposed, a flexible beam will be accelerated during the first part of the move (A₁) and then decelerated during the second part (A₂). However, and as is well known to those of ordinary skill in the art, due to the potentially infinite number of resonant modes, the final position cannot, in practice, be maintained immediately after movement ceases because of the on-going residual vibrations which make take some time to subside. It is this residual vibration that the instant invention is designed to minimize.

The phrase “move time” shall be used herein to refer to the time duration of the feed forward control input, such as acceleration, current, or voltage. “Settle time” will be taken to mean the length of time following the end of the move that is required to achieve the settle criterion, for example ±5% tracking error. Seek time is the sum of the move time and the settle time. FIG. 6 illustrates these concepts for an exemplary a hard disk drive arm movement. The top plot is the current input signal, the middle plot is the resultant position signal, and the bottom plot shows the position signal near the target track. In this instance, the move time is about 2.5 msec. Because of the resonant structure in the flexible system, the position signal cannot settle down immediately after the move. In FIG. 6, the settle time is about 2.5 msec assuming a ±1% tracking error criterion. Of course, it is an objective of the instant robust vibration suppression trajectory generation method to minimize the seek time.

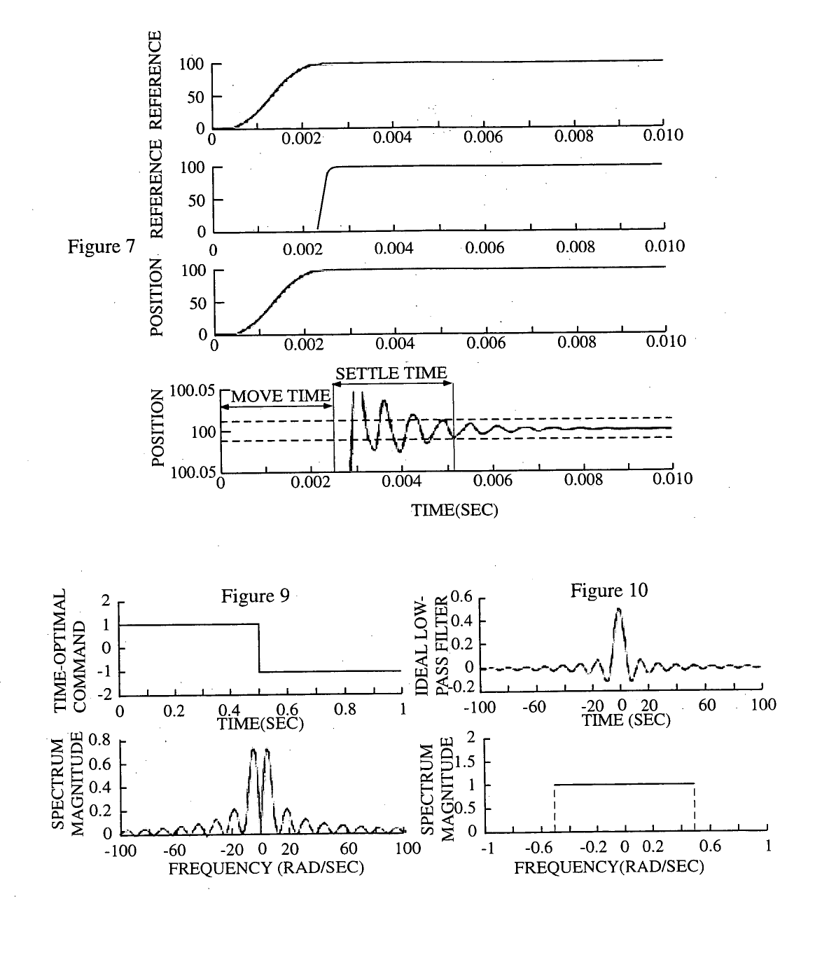

The same concepts apply to closed-loop control. FIG. 7 illustrates a typical move/settle time for a hard disk drive arm movement with closed-loop control. The top two plots are the reference position movement profile and the bottom two plots show the real position signals. In this instance, the move time of the flexible arm is 2.5 msec. Due to the resonant structure in the flexible system, the position signal cannot settle down immediately after the move and the settle time is about 2.5 msec with ±1% tracking error criterion.

Generally speaking, it should be noted that a position reference input can be generated in two preferred ways. First, it can be computed as the integral of a robust vibration suppression velocity profile as shown, for example, in FIG. 8. In this example, since the velocity profile is assumed to be a smooth trajectory that starts and ends at zero, the resultant position reference will similarly have a smooth trajectory.

Alternatively, it can be generated from a step movement command through a finite support filter, f(t), 0≦t≦T. where T is the time duration of the finite support filter. To guarantee that the filtered command reaches the same set point as the step movement command, the integral of f(t) will be imposed to be equal to unity, i.e.,
∫₀^{T}f(t)dt−1
If the original command s(t) is a step reference, say,
s(t)=1, t≧0,
then the filtered command p(t) reaches the original command s(t)=1, t≧0, immediately at the time duration T of the finite support filter, i.e.,
p(t)=s(t), t≧T

This finite support filter f(t), 0≦t≦T, that can generate a vibration suppression position reference profile is called a vibration suppression shape filter, or simply a shape filter. In the discrete-time case, if the finite impulse response shape filter is f [k], 0≦k≦M, the requirement that the integral of f(t) is equal to unity has the following discrete-time analog:

$${\sum }_{k = 0}^{M} f [ k ] = 1$$

Similarly, a normalized robust vibration suppression velocity profile can be used to generate a corresponding reference position profile. Normalization is typically applied to make the velocity profile satisfy the unit integral constraint. More particularly, given a robust vibration suppression velocity profile, v (t), 0≦t≦T, a vibration suppression shape filter f(t) can be generated via the following calculation:

$$f ( t ) = \frac{v ( t )}{{\int }_{0}^{T} v ( t ) ⅆ t} .$$

One advantage of using this sort of shape filter is that the filter itself is a robust vibration suppression velocity profile, so it can be used to generate a smooth vibration suppression position reference.

Those of ordinary skill in the art will recognize that a shape filter does not necessarily need to start and end at zero. By way of example, FIG. 27 shows a step position command, a typical shape filter that has non-zero values at the start and end, and the filtered position reference. Although the shape filter smoothly changes from the start to the end, the initial value at time zero and the final value of the shape filter are not zero.

Furthermore a shape filter can also be a non-smooth function. FIG. 28 shows a step position command, a typical non-smooth shape filter, and the filtered position reference. It shows that the shape filter function is not smooth from the start to the end.

The robust vibration suppression position reference generated from a step command s(t)=S·1(t) through a shape filter, f(t), 0≦t≦T, can also be generated from the integral of a scaled shape filter S·f(t), 0≦t≦T, since

$$\begin{matrix}s ( t ) * f ( t ) = {\int }_{0}^{t} s ( t - τ ) f ( τ ) ⅆ r , \\ = {\int }_{0}^{t} S \cdot 1 ( t - τ ) f ( τ ) ⅆ τ , \\ = {\int }_{0}^{t} S \cdot f ( τ ) ⅆ τ .\end{matrix}$$

Here, “*” is used to represent the convolution operator. Similarly, the robust vibration suppression position reference generated from a step command s(t)=S·1(t) through a discrete-time shape filter, f[k], 0≦k≦M, can also be generated from the integral of a scaled shape filter S·f[k],0≦k≦M.

It should be noted that the vibration suppression shape filters of the sort obtainable by methods discussed herein can also be used to shape other control profiles. The control profile here refers to the trajectories in the control system, such as acceleration, velocity, or position signals.

In theory, the most efficient way to reduce the move time of a flexible system is to use a time-optimal control input which has the bang-bang form. However, in practice, to suppress the high frequency residual vibration, the control input must have a small energy distribution at high frequencies (i.e. the control input should behave like an ideal low-pass filter). Heretofore it has not bee recognized that a signal can be found which achieves the two properties simultaneously, i.e., a signal that minimizes the functional expression in both the time and frequency domains. The following analysis makes clearer this phenomenon. FIG. 9 shows a typical time-optimal command and its spectrum magnitude. Of course, the time-optimal command has a sharp decay in the time domain but a very slow decay in the frequency domain. FIG. 10 illustrates a typical ideal low-pass filter function and its spectrum. Similarly, the ideal low-pass filter function has a sharp decay in the frequency domain but a very slow decay in the time domain.

In the communication field, it is known that one cannot simultaneously confine a function h(t) and its Fourier transform H(jω) too strictly. This phenomenon is clearly stated by the Heisenberg Uncertainty Principle: if the time-spread Δₕ₍ₜ₎ of h(t) is measured by

$${Δ}_{h ( t )}^{2} = \frac{{\int }_{- ∞}^{∞} {( t - {t}^{*} )}^{2} {\vert h ( t ) \vert}^{2} ⅆ t}{{\int }_{- ∞}^{∞} {\vert h ( t ) \vert}^{2} ⅆ t}$$

and the frequency-spread Δ_{H(jω)} of H(jω) is measured by

$${Δ}_{H ( jω )}^{2} = \frac{{\int }_{- ∞}^{∞} {( ω - {ω}^{*} )}^{2} {\vert H ( jω ) \vert}^{2} ⅆ ω}{{\int }_{- ∞}^{∞} {\vert H ( jω ) \vert}^{2} ⅆ ω}$$

where t* is defined as center of h(t) and ω* is defined as center of H(ω) by

$${t}^{*} = \frac{{\int }_{- ∞}^{∞} t {\vert h ( t ) \vert}^{2} ⅆ t}{{\int }_{- ∞}^{∞} {\vert h ( t ) \vert}^{2} ⅆ t}$$

$$and$$

$${ω}^{*} = \frac{{\int }_{- ∞}^{∞} ω {\vert H ( jω ) \vert}^{2} ⅆ ω}{{\int }_{- ∞}^{∞} {\vert H ( jω ) \vert}^{2} ⅆ ω} .$$

then,

$${Δ}_{h ( t )} {Δ}_{H ( jω )} \geq \frac{1}{2} .$$

Thus, Δₕ₍ₜ₎ and Δ_{H(jω)} cannot, for any Fourier transform pair, be both small. Furthermore, equality will hold if h(t) (and hence H(jω) are Gaussian.

A simple form of a Gaussian function is given by the expression

$$h ( t ) = {ⅇ}^{- \frac{{t}^{2}}{2}} .$$

The derivative of (13) is given by

$$ϕ ( t ) = - t {ⅇ}^{( - \frac{1}{2} {t}^{2} )}$$

The derivative of φ(t) is given by

$$\frac{ⅆ}{ⅆ t} ϕ ( t ) = - ( 1 - {t}^{2} ) {ⅇ}^{( - \frac{1}{2} {t}^{2} )}$$

which is the equation for the so-called Mexican hat wavelet.

Now the waveform of φ(t) is considered from the spectrum point of view. The Fourier transform φ(jω)=∫_{-∞}^{∞}φ(t)e^{-jωt}dt is given as

$$Φ ( jω ) = j \sqrt{2 π} {ωⅇ}^{( - \frac{1}{2} {ω}^{2} )}$$

From the form of the previous equation, it should be clear that Φ(jω) decays very quickly such that the value of Φ(jω) at some ω becomes for all practical purposes negligible. Further, because of the functional form of the preceding expression the total energy of Φ(jω) is concentrated locally near zero.

Since the value of φ(t) is negligibly small as |t| becomes larger, φ(t) may be truncated to lie within the range of −D≦t≦D to obtain a time-limited version of φ(t), then shifted forward to make the start time equal to zero and end time equal to 2D, e.g.,

$$g ( t ) = \{ \begin{matrix}ϕ ( t - D ) & if 0 \leq t \leq 2 D ; \\ 0 , & otherwise .\end{matrix}$$

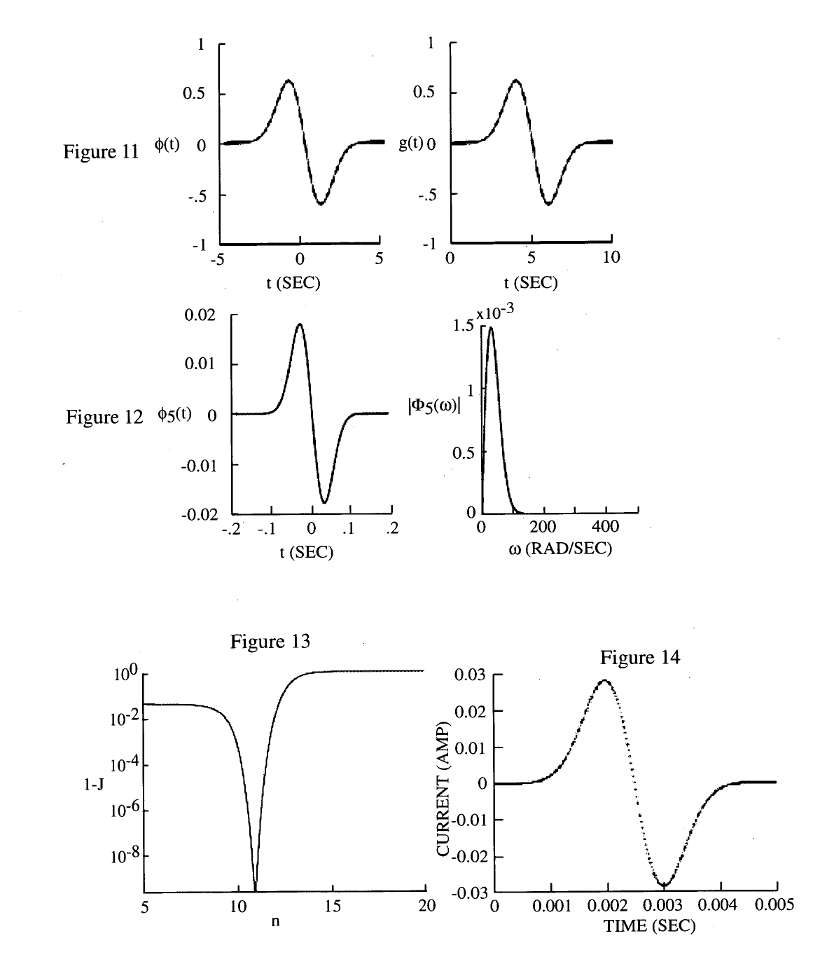

FIG. 11 shows the g(t) and φ(t) waveforms for D=5. Referring to FIG. 5, it should be clear that g(t) could be used as an acceleration candidate for a double integrator system. To guarantee the position constraint, a gain K must be multiplied by the waveform of g(t). Since φ(t) decays rapidly as t increases, the energy distribution of g(t), which is the shifted time-limited version of φ(t), approaches the energy distribution of φ(t). Thus, if the resonance frequencies of the flexible structure are located at the region where the spectrum of g(t) is negligibly small, g(t) cannot induce residual vibrations of the flexible system. In this case, most of the energy of g(t) is concentrated before the first resonance frequency, so this acceleration functional form can be used to suppress the residual vibration caused by all the resonance needs.

Considering the similar waveforms of φ(t) but with a different time localization and frequency localization, a scaled version of the foregoing may be introduced as follows

$$ϕ ( n , t ) = - t {ⅇ}^{( - \frac{1}{2} {2}^{( 2 n )} {t}^{2} )} ,$$

where n is a real number.

Note the following properties of φ(n,t): The maximum of φ(n,t) is

$$\frac{{ⅇ}^{- 1 / 2}}{{2}^{n}} ,$$

which is achieved at time

$$- \frac{1}{{2}^{n}} .$$

The minimum of

$$ϕ ( n , t ) is - \frac{{ⅇ}^{- 1 / 2}}{{2}^{n}} ,$$

which is achieved at time

$${t}_{m} = \frac{1}{{2}^{n}} .$$

So, as n increases, the waveform of φ(n,t) is concentrated near zero, and the absolute value of φ(n,t) decreases. As n decreases, the waveform of φ(n,t) becomes wide and the absolute value of peak φ(n,t) increases.

The Fourier transform Φ(n,jω)=∫_{-∞}^{∞}φ(n,t)e^{-jωt}dt can be shown to be equal to

$$Φ ( n , jω ) = \frac{j \sqrt{2 π} {ωⅇ}^{( \frac{{1}^{{ω}^{2}}}{{2}_{2}^{( 2 n )}} )}}{{2}^{( 3 n )}} .$$

Note the following properties of Φ(n,jω): The maximum of

$$\vert Φ ( n , jω ) \vert is \frac{\sqrt{2 π} {ⅇ}^{- 1 / 2}}{{2}^{( 2 n )}} ,$$

which is achieved at frequency ωₘ=2ⁿ. As n increases, the waveform of Φ(n,jω) becomes wide and the maximum of |Φ(n, jω)| decreases. As n decreases, the waveform of Φ(n,jω) becomes narrow and the maximum of |Φ(n,jω)| increases.

Since tₘωₘ=1 holds, tₘ and ωₘ cannot be decreased or increased simultaneously. To demonstrate this characteristic and see how the waveforms of φ(n,t) and Φ(n,jω) change with n, the waveforms of φ(5,t) and |Φ(5,ω)| are plotted in FIG. 11, and the waveforms of φ(−5,t) and |Φ(−5,ω)| are plotted in FIG. 12.

Since the values of φ(n,t) become negligibly small as |t| becomes large, φ(n,t) may be truncated at the range of −D≦t≦D to obtain a time-limited version of φ(n,t), then shifted forward to make the start time equal to zero and end time equal to 2D:

$$g ( n , t ) = \{ \begin{matrix}ϕ ( n , t - D ) & if 0 \leq t \leq 2 D ; \\ 0 , & otherwise .\end{matrix}$$

As a consequence, it should now be clear that g(n,t) can be used as an acceleration profile for a double integrator system. To insure that the position constraint is met, a constant gain K must be multiplied by the waveform g(n, t). Since φ(n,t) decays rapidly as t increases, the energy distribution of g(n,t), which is the shifted, time-limited version of φ(n,t) nears the energy distribution of φ(n,t). So, if the resonance frequencies of the flexible structure are located in the region where the spectrum of g(n,t) is negligibly small, then g(n,t) will not induce significant residual vibration in the system. In this case, since most of the energy of g(n,t) is concentrated below the first (smallest) of the potentially numerous resonance frequencies, this waveform has the potential to minimize the residual vibration caused by all of the resonance modes.

The Fourier transform of the truncated version of φ(n,t) is very difficult to calculate even though Φ(n,jω) is very easy to calculate. Those of ordinary skill in the art will recognize that one expression of G(n,jω) involves the complex error function, which will not be discussed at any length herein. However, a discrete time Fourier transform may be used instead as is demonstrated below.

Assuming for purposes of illustration that a sampling period of Tₛ sec has been selected and that there are a total of M+1 samples, the expression for gₙ[k] may be determined to be:

$${g}_{n} [ k ] = \{ \begin{matrix}ϕ ( n , ( k - \frac{M}{2} ) {T}_{s} ) , & if 0 \leq t \leq 2 D ; \\ 0 , & otherwise .\end{matrix}$$

Note that he discrete-time sequence gₙ[k], 0≦k≦M is antisymmetric, and

$$\frac{M}{2}$$

is the center of symmetry.

When M is even, the discrete-time Fourier transform Gₙ(e^{jω})=Σ_{k=-∞}^{∞}gₙ[k]e^{-jωk} is

$$\begin{matrix}{G}_{n} ( {ⅇ}^{jω} ) = {jⅇ}^{- jω M / 2} [ {\sum }_{k = 1}^{M / 2} 2 {g}_{n} [ M / 2 - k ] sin ( ω k ) ] \\ = {jⅇ}^{- jω M / 2} [ 2 {\sum }_{k = 1}^{M / 2} ϕ ( n , - {kT}_{s} ) sin ( ω k ) ] .\end{matrix}$$

The magnitude of Gₙ(e^{jω}) for even M is

$$\vert {G}_{n} ( {ⅇ}^{jω} ) \vert = \vert 2 {\sum }_{k = 1}^{M / 2} ϕ ( n , - {kT}_{s} ) sin ( ω k ) \vert$$

When M is odd, the discrete-time Fourier transform Gₙ(e^{jω})=Σ_{k=-∞}^{∞}[k]e^{-jωk} is

$$\begin{matrix}{G}_{n} ( {ⅇ}^{jω} ) = {jⅇ}^{- jω M / 2} [ {\sum }_{k = 1}^{( M + 1 ) / 2} 2 {g}_{n} [ ( M + 1 ) / 2 - k ] sin ( ω ( k - 1 / 2 ) ) ] \\ = {jⅇ}^{- jω M / 2} [ 2 {\sum }_{k = 1}^{( M + 1 ) / 2} ϕ ( n , ( \frac{1}{2} - k ) {T}_{s} ) sin ( ω ( k - 1 / 2 ) ) ] .\end{matrix}$$

The magnitude of Gₙ(e^{jω}) for odd M is

$$\vert {g}_{n} ( {ⅇ}^{jω} ) \vert = \vert 2 {\sum }_{k = 1}^{( M + 1 ) / 2} ϕ ( n , ( \frac{1}{2} - k ) {T}_{s} ) sin ( ω ( k - 1 / 2 ) ) \vert .$$

In contrast to the continuous-time Fourier transform of g_{φ,n}(t), the discrete-time Fourier transform of g_{φ,n}(k) can be easily calculated.

Given a fixed move time, the acceleration profile can then be determined after choosing the scaling parameter n. In a preferred embodiment, the scaling parameter will be selected by reference to a Bode magnitude plot of the resonance structure for the flexible arm. Preferably, the first/smallest resonance frequency will be located, such smallest frequency being referred to hereinafter as Ω₀ (rad/sec). Given that quantity, n may be obtained by finding extrema of the following objective function, where ω₀=Ω₀Tₛ, and Tₛ is the sampling period in seconds.

$$J = \frac{{\int }_{0}^{{ω}_{0}} {\vert {G}_{ϕ , n} ( ω ) \vert}^{2} ⅆ ω}{{\int }_{0}^{π} {\vert {G}_{ϕ , n} ( ω ) \vert}^{2} ⅆ ω}$$

or, equivalently,

$$1 - J = \frac{{\int }_{0}^{π} {\vert {G}_{ϕ , n} ( ω ) \vert}^{2} ⅆ ω - {\int }_{0}^{{ω}_{0}} {\vert {G}_{ϕ , n} ( ω ) \vert}^{2} ⅆ ω}{{\int }_{0}^{π} {\vert {G}_{ϕ , n} ( ω ) \vert}^{2} ⅆ ω} .$$

The following optimization problem is then preferably used to determine the optimal value of n.

$${max}_{n} J or {min}_{n} ( 1 - J )$$

Physically, the objective functions represent the fact that the best waveform of g_{φn}[k] has maximum amount of energy in the frequency band below the first resonance frequency, or, in other words, it minimizes the proportion of its energy contained in frequencies above the first resonance frequency, according to an arbitrary move time. For engineering applications, the previous integral equations can be easily approximated by the cumulative summation of the element |G_{φ,n}(ω)|². So, in some preferred embodiments, the value of n may be determined without reliance on optimization algorithms and, instead, the optimal n might be chosen by reference to a plot of J or 1−J in terms of n. That being said, it is anticipated and in many circumstances numerical methods will be used to solve the maximization/minimization problem presented above.

Of course, given a Gaussian reference velocity function that has been obtained according to the methods discussed hereinafter, the acceleration, jerk, position and other profiles can be derived to synthesize the control input signals to suppress the residual vibration in a flexible system. Those of ordinary skill in the art will know how to calculate any of the foregoing from a given velocity profile and, in more particular, will know how to calculate any of the foregoing that are not calculated as part of an example herein.

The following numerical example illustrates how the instant invention would preferably be utilized in practice. Consider a flexible system that is embedded in a hard disk assembly, where the input is the current signal in amps and the output is the position signal in tracks.

$$H ( s ) = Kc \cdot Kv \cdot Kp \cdot R ( s ) \frac{1}{{s}^{2}} , \\ where$$

$$Kc = 1.3 \frac{tracks / {sample}^{2}}{amp}$$

is a constant gain from current to acceleration,

$$Kv = 5 \times {10}^{4} \frac{tracks / samples}{amp}$$

is the velocity gain,

$$Kp = 5 \times {10}^{4} \frac{tracks / samples}{amp}$$

is the position gain, and R(s) is a 20^{th} order resonance structure. The Bode magnitude plot of R(s) that will be used for purposes of this example is shown in FIG. 4.

FIG. 13 illustrate the change in the value of the objective 1−J as a function of n for Ω_{c}=9.68×10³ rad/sec, Tₛ=2×10⁻⁵ sec and wherein the move time is chosen to be 5×10⁻³ sec. The vertical axis is logarithmic. In this case, n was determined to be about 10.93.

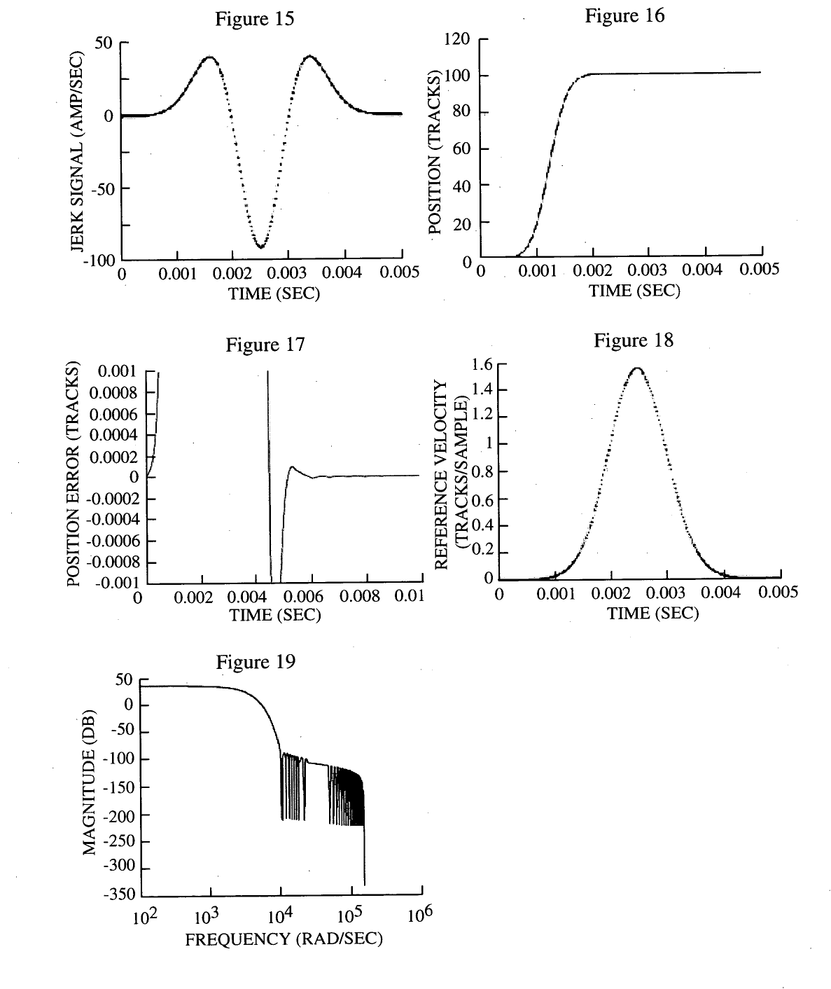

Given a near-optimal value of n as determined above, the current signal for, say, a 100 track seek can then readily be calculated. FIG. 14 shows the current signal under the parameter assumptions listed above, FIG. 15 shows the jerk signal which is the derivative of the current signal, and FIG. 16 shows the position signal. To better see the residual vibration, the position error signal, which is defined as the position output difference between H(s) and the reference model H_{ref}(s) can be plotted, where H_{ref}(s) is defined as

$${H}_{ref} ( s ) = Kc \cdot Kv \cdot Kp \frac{1}{{s}^{2}} .$$

FIG. 17 shows that the position signal settles within ± 1/1000 track before the move time of 5×10⁻³ sec. So, the current signal suppresses the residual vibration induced by all the resonance modes.

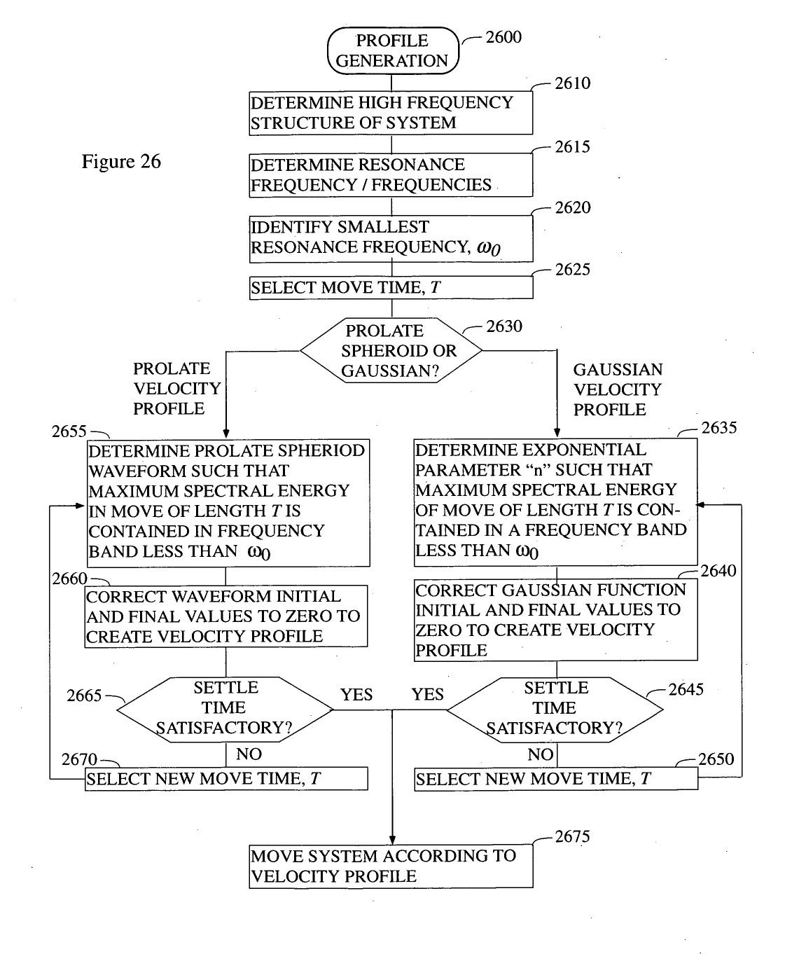

Next, the current signal for the previous example will be analyzed from the filter point of view. FIG. 18 illustrates the reference velocity signal which is the integral of the acceleration signal. This signal is the impulse response of a finite response filter. The magnitude of the frequency response of this finite response filter is shown in FIG. 26. By reference to this figure, it should be clear that this filter has very good rejection of high frequency signals.

It should be noted that the move time cannot be arbitrarily reduced if a certain settling time is required. The ability to shorten the move time will obviously depend on the resonance characteristics. As shown before, a signal cannot arbitrarily achieve both time and frequency localization. Reducing the move time will predictably result a relatively broader and less desirable frequency distribution. There will always be a tradeoff between the move time of a control input and its concentration in the frequency domain.

According to still another preferred embodiment of the instant invention, there is provided an invention substantially as described above, but wherein a robust velocity profile is generated directly from a Gaussian function that is designed to minimize the time-frequency localization of the profile in the sense of Heisenberg uncertainty.

By way of explanation, a scaled version of the simple Gaussian function may be written as follows:

$${h}_{n} ( t ) = {ⅇ}^{- \frac{1}{2} {2}^{2 n} {t}^{2}} .$$

Since the value of hₙ(t) is negligibly small as |t| becomes large, hₙ(t) may be truncated at the range of −D≦t≦D to obtain a time-limited version of hₙ(t) then shifted forward to make the start time equal to zero and the end time equal to 2D:

$${g}_{h , n} ( t ) = \{ \begin{matrix}{h}_{n} ( t - D ) & if 0 \leq t \leq 2 D ; \\ 0 , & otherwise .\end{matrix} .$$

If the sampling period is Tₛ sec and the total discrete-time sequence has M+1 impulses, a discrete time version of the previous equation may be shown to be:

$${g}_{h , n} [ k ] = \{ \begin{matrix}{h}_{n} ( ( k - \frac{M}{2} ) {T}_{s} ) , & if 0 \leq k \leq M ; \\ 0 , & otherwise .\end{matrix}$$

Of course, the discrete-time sequence g_{h,n}[k], k=0, 1, . . . , M, is symmetric and M/2 is the center of symmetry.

If M is an even integer, the discrete-time Fourier transform of g_{h,n}[k] is:

$${G}_{h , n} ( ω ) = {ⅇ}^{- jω M / 2} [ {\sum }_{k = 0}^{M / 2} a [ k ] cos ( ω k ) ]$$

$$where$$

$$a [ 0 ] = {g}_{h , n} [ M / 2 ]$$

$$a [ k ] = 2 {g}_{h , n} [ M / 2 - k ]$$

$$k = 1 , 2 , L , M / 2.$$

The magnitude of G_{h,n}(ω) for even M is

$$\vert {G}_{h , n} ( ω ) \vert = \vert {\sum }_{k = 0}^{M / 2} a [ k ] cos ( ω k ) \vert .$$

If M is odd, the discrete-time Fourier transform of g_{h,n}[k] is:

$${G}_{h , n} ( ω ) = {ⅇ}^{- jω M / 2} [ {\sum }_{k = 1}^{( M + 1 ) / 2} b [ k ] cos ( ω ( k - \frac{1}{2} ) ) ] , \\ where \\ b [ k ] = 2 {g}_{h , n} [ ( M + 1 ) / 2 - k ] \\ k = 1 , 2 , L , \frac{M + 1}{2} .$$

It then follows that the magnitude of G_{h,n}(ω) for odd M is

$$\vert {G}_{h , n} ( ω ) \vert = \vert {\sum }_{k = 1}^{( M + 1 ) / 2} b [ k ] cos ( ω ( k - \frac{1}{2} ) ) \vert .$$

As has been discussed previously, given a fixed time duration a shape filter profile can be determined according to a preferred aspect of the instant invention by choosing the scaling parameter n. The value of n can be computed from the characteristics of the uncertain resonance structure as illustrated above. Assume, for purposes of discussion, that the first resonance frequency the system is located at Ω₀ rad/sec. Then, an objective can be defined in terms of ω₀=Ω₀Tₛ where Tₛ is the sampling period in seconds, in a manner analogous to that discussed previously:

$$J = \frac{{\int }_{0}^{{ω}_{0}} {\vert {G}_{h , n} ( ω ) \vert}^{2} ⅆ ω}{{\int }_{0}^{π} {\vert {G}_{h , n} ( ω ) \vert}^{2} ⅆ ω}$$

$$or$$

$$1 - J = \frac{{\int }_{0}^{π} {\vert {G}_{h , n} ( ω ) \vert}^{2} ⅆ ω - {\int }_{0}^{{ω}_{0}} {\vert {G}_{h , n} ( ω ) \vert}^{2} ⅆ ω}{{\int }_{0}^{π} {\vert {G}_{h , n} ( ω ) \vert}^{2} ⅆ ω} .$$

In a preferred variation, the instant invention will proceed by determining an optimal (maximum or minimum) value of J as a function of n as has been described previously. After the n-optimal profile g_{h,n}[k], 0≦k≦M, has been calculated, g_{h,n}[k] will preferably be normalized, thereby yielding the filter t[k]:

$$f [ k ] = \{ \begin{matrix}\frac{{g}_{h , n} [ k ]}{{\sum }_{m = 0}^{M} {g}_{h , n} [ m ]} , & if 0 \leq k \leq M ; \\ 0 , & otherwise .\end{matrix}$$

Notice that the initial and final values of the sequence g_{h,n}[k], 0≦k≦M, are not zero, so that sequence cannot be directly used as a robust velocity profile of the sort discussed herein. But, as discussed previously, a simple adjustment converts the sequence g_{h,n}[k] to one that is suitable as a velocity profile (i.e., it can be vertically shifted downward to make the starting and ending values identically equal to zero):
vel[k]=g_{h,n}[k]−g_{h,n}[0], 0≦k≦M.
Of course, since g_{h,n}[0]=g_{h,n}[M] (because the sequence is symmetric about M) a correction that is applied to one tail will similarly correct the other tail. Depending on the rigid body position movement, the velocity may need to be multiplied by a constant. The discrete-time acceleration profile acc[k] can be generated from the discrete-time velocity profile vel[k] by differencing the velocity profile

$$acc [ k ] = \frac{vel [ k + 1 ] - vel [ k ]}{{T}_{s}} ,$$

where Tₛ is the sampling period. Depending on the rigid body position movement, the acceleration profile may similarly need to be multiplied by a constant.

Turning next to another aspect of the instant invention, there is provided a preferred method of generating a robust vibration suppression profile suitable for use in both open-loop and closed loop systems which utilizes a shifted prolate spheroidal wave function as a velocity profile. Note that, after determination of the reference velocity according to the methods discussed hereinafter, the acceleration, jerk, position and other profiles can readily be derived to synthesize the control input signals to suppress the residual vibration in a flexible system.

By way of general background, as is well known to those of ordinary skill in the art, prolate spheroidal wave functions have certain time/frequency domain properties that make them useful in communications theory. That is, if α²(T) represents the fraction of the signal's energy that lies in the time interval [−T/2, T/2]:

$${α}^{2} ( T ) := \frac{{\int }_{- T / 2}^{T / 2} {\vert f ( t ) \vert}^{2} ⅆ t}{{\int }_{- ∞}^{∞} {\vert f ( t ) \vert}^{2} ⅆ t} ,$$

and β²(Ω) is a measure of the concentration of the amplitude spectrum of f(t) within the frequency range [Ω,−Ω]:

$${β}^{2} ( Ω ) := \frac{{\int }_{- Ω}^{Ω} {\vert F ( ω ) \vert}^{2} ⅆ ω}{{\int }_{- ∞}^{∞} {\vert F ( ω ) \vert}^{2} ⅆ ω}$$

then, it has been shown that there are a countably infinite set of functions ¢₀(t), ¢₁(t), ¢₂(t), . . . and a set of corresponding λᵢ=α²(T), i=0,1,2, . . . , such that
λ₀>λ₁>λ₂>L
with the best choice of f(t) (i.e., the band limited function with the greatest concentration of energy within the frequency range [Ω,−Ω]) being given by the first shifted spheroidal wave function:
f(t)=¢₀(t+T/2,c).
where c=ΩT/2. Of course, this property is one that is well suited to the instant investigation.

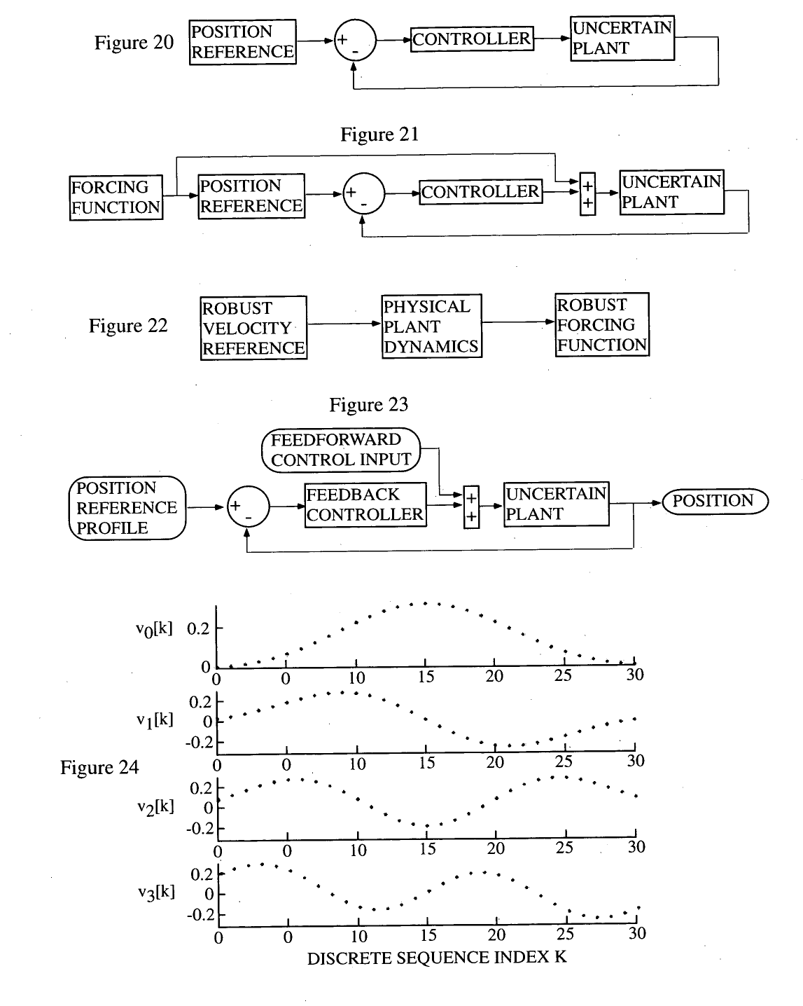

FIG. 20 contains a schematic diagram of a standard closed-loop control scheme. The position reference is the reference input to the closed-loop system. The robust position reference can be generated from the robust velocity reference or a step movement command through a vibration suppression shape filter has been demonstrated previously.

FIG. 21 contains a schematic diagram of another kind of closed-loop control scheme. In this control scheme, the forcing function signal is sent directly to both the uncertain plant and a reference model of the plant. The controller takes as its input the tracking error, which is the difference of the real position and the position reference generated by the reference model. The robust forcing function can be generated from a robust velocity profile through the physical system dynamics as shown in FIG. 22.

In practice, the position reference from the reference model may be saved in a table and directly used as a reference input as shown in FIG. 23. Of course, instead of continuous-time prolate spheroidal wave functions, discrete prolate spheroidal sequences (DPSS's) are preferably used to generate the robust vibration suppression shape filter and control profile.

Numerical methods for calculating DPSS coefficients are well known and will not be discussed herein except to note that routines for doing such are widely available in standard mathematics computation packages. For example, in the Matlab® Signal Processing Toolbox, the Matlab® routine [v,e]=dpss(n, n*W) may be used to generate DPSS's of length n in the columns of the matrix v, and their corresponding concentrations in vector e, where W is the normalized half-bandwidth, 0≦W≦1/2. Although the Matlab® routine dpss is typically used for multi-taper spectral analysis, it can be directly used here to generate a robust vibration suppression profile according to the approach of the instant invention. The examples that follow were calculated using this Matlab® routine.

As a specific example of how prolate spheroid wave functions would be used in practice to create a robust velocity profile, consider a case where the frequency bandwidth is assumed to be Ω₀=9.68×10³ rad/sec, the time duration of the DPSS is chosen to be 1.5×10⁻³ sec, and the sampling period of the discrete sequence is Tₛ=5×10⁻⁵ sec. The first four discrete prolate spheroidal sequences as obtained from Matlab® are shown in FIG. 24. Their corresponding energy concentrations are λ₀=0.999 995, λ₁=0.999 730, λ₂=0.993 707, and λ₃ =0.926 472, respectively. As discussed previously, the first discrete prolate spheroidal sequence v₀[k] achieves an optimal energy concentration in the frequency band [−Ω₀, Ω₀]. A robust vibration suppression shape filter can be generated from the first discrete prolate spheroidal sequence v₀[k] by

$$f [ k ] = \frac{{v}_{0} [ k ]}{{\sum }_{k = 0}^{N - 1} {v}_{0} [ k ]}$$

$$k = 0 , 1 , L , N - 1 ,$$

where N is the total data number of the sequence v₀[k].

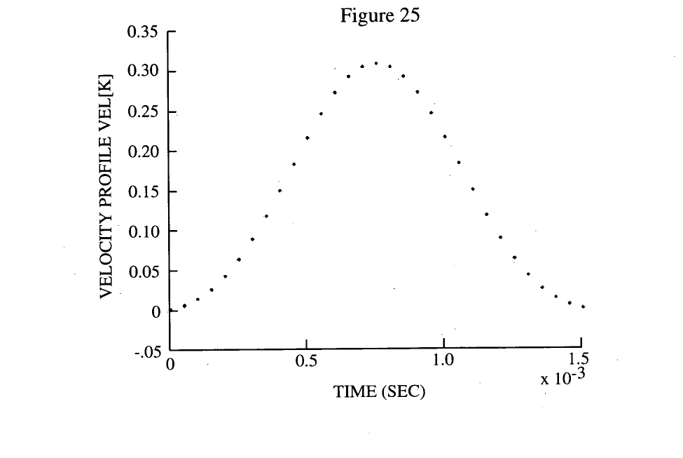

Since the initial and final values of the sequence v₀[k] are not zero, the sequence v₀[k] cannot be directly used as a robust vibration velocity profile. From the waveform of v₀[k], it is clear that the v₀[k] behaves like Gaussian functions in that the values decay sharply at the start and end points. As a consequence, the sequence v₀[k] can be vertically shifted downward to make the start and end values to be zero,
vel[k]=v₀[k]−v₀[0], k=0,1,2,L, N−1.
Notice that v₀[0]=v₀[N−1] because the sequence is a symmetric function. The sequence vel[k], k=0, 1, . . . , N−1, can be used as a velocity profile. The resultant exemplary robust vibration suppression velocity profile is shown in FIG. 25. Depending on the rigid body position movement, the velocity profile may be multiplied by a constant.

Of course, the discrete-time sequence of the acceleration profile acc[k] can then be generated by differencing the velocity profile vel[k]:

$$acc [ k ] = \frac{vel [ k + 1 ] - vel [ k ]}{{T}_{s}} ,$$

where Tₛ is the sampling period. Again, depending on the rigid body position movement, the acceleration profile may need to be multiplied by a constant.

Applying a vertical shift to the discrete prolate spheroidal sequence vel[k] very slightly impairs its energy concentration properties depending on the amount of shift. For the above example, the energy concentration measure β²(W) of vel[k] is approximately 0.999 979. Compared with the optimal energy concentration value being λ₀=0.999 995, the vertically shifted version of v₀[k], i.e., vel[k] only loses a little energy concentration. With the decrease of the move time, the difference of the energy concentration measure between v₀[k] and vel[k]=v₀[k]−v₀[0] will increase. Those of ordinary skill in the art will recognize that there will always be a tradeoff between the energy concentration measure and time duration when the first resonance frequency Ω₀ and the sampling period Tₛ are determined.

Notice that, as another preferred embodiment, the second discrete prolate spheroidal sequence v₁[k] in FIG. 25 can be directly used as an acceleration profile. In that case, the resultant velocity profile is almost the same as vel[k] in the sense of energy concentration in the frequency band ω≦|Ω₀|.

As a final example, a discrete prolate spheroidal sequence will be used to design a robust acceleration profile for use in a hard disk drive arm. Consider a flexible system which is embedded in a hard disk assembly, where the input is the current signal in amps and the output is the position signal in tracks. As before, the modeling function H(s) will be used with

$$Kc = 8.125 \frac{tracks / {sample}^{2}}{amp}$$

being a constant gain from current to acceleration,

$$Kv = 1 / {T}_{s} = 2 \times {10}^{4} \frac{samples}{sec}$$

being the velocity gain,

$$Kp = 1 / {T}_{s} = 2 \times {10}^{4} \frac{samples}{sec}$$

being the position gain, and R(s) being the 28^{th} order resonance structure. With parameters settings of Ω₀=9.68×10³ rad/sec, a move time of 2.5×10⁻³ sec, and a sampling period of Tₛ=5×10⁻⁵ sec, prolate discrete spheroidal wave functions are calculated as described previously. The corresponding concentrations of zeroth order and first order DPSS's in the frequency band |ω|≦Ω₀ are approximately 0.999 999 999 and 0.999 999 937. So the waveform v₀[k] provides the best concentration to cut off the high frequency resonance components. The acceleration profile acc[k] can be derived from v₀[k] through differencing. Alternatively, v₁[k] can be directly used as the acceleration profile candidate. Based on these computations, the resultant velocity profile can be shown to be almost the same as vel[k] in the sense of energy concentration in the frequency band ω≦|Ω₀|.

Finally, and turning now to FIG. 26, the preferred embodiments may be better understood by reference to the profile generation logic diagram 2600 contained in this figure. In more particular, as a first preferred step 2610, the high frequency structure of the system will be determined. This will preferably include at least the determination of some number of the resonance frequencies for that system (step 2620) as well as the identification of the smallest resonance frequency (step 2630).

As a next preferred step, a move time T will be selected (step 2625). As has been discussed previously, there is a tradeoff between move time and frequency concentration and, as is discussed below, it may be necessary to try several different values before a satisfactory one is obtained.

Next, a decision will need to be made (step 2630) as to whether to use a Gaussian or prolate spheroid velocity profile. In the event that Gaussian is chosen, a scale factor (e.g., the parameter n) will need to be determined based on the move length and minimum resonance frequency. After that value is determined, the resulting Gaussian function will preferably be zeroed (step 2640) at each end (i.e., the initial and final samples will be set to zero) to convert it to an acceptable velocity function.

In some preferred embodiments, the settle time for the given system / Guassian waveform combination will be determined either using appropriate hardware or computer simulation. Obviously this step is optional and might be useful, for example, during prototyping. If the settle time is satisfactory (the “yes” branch of decision item 2645) the calculated velocity profile will preferably be used to move the system (step 2675). Note that the term “satisfactory” is meant to apply both to situations where the settle time is too long (i.e., the movement time was too short) as well as those instances where the settle time is too short (i.e., the arm could be moved more quickly to its final position without exceeding the target design).

Returning now to the decision item 2630, if the prolate spheroid waveform is to be used as a velocity profile, preferably a suitable waveform will be determined in view of the move time and smallest resonance frequency as has been discussed previously (step 2655). Additionally, in the preferred embodiment the resulting waveform will be converted to a true velocity function by correcting the initial and final values of waveform to zero (step 2660).

Finally, and as discussed supra, if the settle time is not satisfactory (decision box 2665), preferably a new move time will be selected (step 2670) and the process repeated. On the other hand, if the settle time is satisfactory (the “yes” branch of decision item 2665) the arm will be moved according to the velocity profile obtained in step 2660.

### Conclusions

Finally, although the instant invention has been described herein as operating on disk drive arms, those of ordinary skill in the art will recognize that other areas of application are certainly possible. For example, the instant method could be beneficially used with the movement of computer controlled electromechanical devices including spacecraft (satellite), space-borne robots, general robotic arms, precision manufacturing equipment, etc.

Further, although the calculation of robust velocity and/or acceleration functions has been extensively discussed herein, that was done for purposes of specificity only and not out of any intent that the instant invention be so limited. That is, those of ordinary skill in the art will recognize the interchangeability between velocity, acceleration, jerk, position, trajectory and other profiles: given one, the others may readily be calculated. As a consequence, when calculation of a robust velocity profile is called for herein, that language should be broadly understood to mean both the literal calculation of a velocity profile, as well as all of its computational equivalents.

While the invention has been described and illustrated herein by reference to a limited number of embodiments in relation to the drawings attached hereto, various changes and further modifications, apart from those shown or suggested herein, may be made therein by those skilled in the art, without exceeding the scope of what has been invented, the scope of which is to be determined only by reference to the following claims.

What is claimed is:

1. A method of moving a flexible dynamic system from an initial position to a final position, comprising the steps of:
(a) determining at least one resonance frequency of the system;
(b) determining a smallest of said at least one resonance frequencies;
(c) selecting a move time;
(d) selecting a velocity profile function, wherein said velocity profile function has at least one parameter associated therewith;
(e) using at least said selected move time to determine a value for each of said at least one parameters such that a near maximum spectral energy in said velocity profile function is contained within frequencies less than said smallest resonance frequency; and,
(f) moving said flexible dynamic system from the initial position to the final position at least according to said move time, said velocity profile function, and said at least one values of said parameters.

2. A method of moving a flexible dynamic system from an initial position to a final position according to claim 1, wherein said flexible dynamic system is selected from a group consisting of a disk drive arm and a robot arm.

3. A method of moving a flexible dynamic system from an initial position to a final position according to claim 1, wherein said velocity profile function is selected from a group consisting of a Gaussian function and a prolate spheroid function.

4. A method of moving a flexible dynamic system from an initial position to a final position according to claim 3, wherein said velocity profile function is a Gaussian function h,(t) of the form,
$${h}_{n} ( t ) = {ⅇ}^{- \frac{1}{2} {2}^{2 n} {t}^{2}}$$
wherein n is a parameter associated with said Gaussian function, and t is a variable representing time.

5. A method of moving a flexible dynamic system from an initial position to a final position according to claim 4, wherein step (e) comprises the step of
(e1) using at least said selected move time to determine said parameter n such that a near maximum spectral energy in said velocity profile function is contained within frequencies less than said smallest resonance frequency, parameter n begin determined by at least approximately maximizing a variable J with respect to n, where J is defined to be:
$$J = \frac{{\int }_{0}^{{ω}_{0}} {\vert {G}_{h , n} ( ω ) \vert}^{2} ⅆ ω}{{\int }_{0}^{π} {\vert {G}_{h , n} ( ω ) \vert}^{2} ⅆ ω}$$
wherein ω₀ is said smallest resonance frequency, and G_{h,n}(ω) is a Fourier transform of a time shifted version of h(t),
$${g}_{h , n} ( t ) = \{ \begin{matrix}{h}_{n} ( t - D ) & if 0 \leq t \leq 2 D ; \\ 0 , & otherwise .\end{matrix}$$
and D is one half of said move time.

6. A method of determining a velocity profile for use in moving a flexible dynamic system from an initial position to a final position, comprising the steps of:
(a) determining at least one resonance frequency of the system;
(b) determining a smallest of said at least one resonance frequencies;
(c) selecting a move time;
(d) selecting a velocity profile function, wherein said velocity profile function has at least one parameter associated therewith;
(e) using at least said selected move time to determine a value for each of said at least one parameters such that a near maximum spectral energy in said velocity profile function is contained within frequencies less than said smallest resonance frequency; and,
(f) storing in a computer readable medium at least indicia representative of said at least one parameter values and said selected velocity profile function for use in moving said flexible dynamic system from the initial position to the final position.

7. A method of determining a velocity profile for use in moving a flexible dynamic system from an initial position to a final position according to claim 6, comprising the further step of:
(g) reading from said computer readable medium at least said stored indicia representative of said at least one parameter values and said selected velocity profile function; and,
(h) moving the flexible dynamic system from the initial position to the final position at least according to said move time, said read indicia representative of said selected velocity profile function, and said read indicia of representative of said at least one parameter values.

8. A method according to claim 6, wherein said computer readable medium is selected from a group consisting of a magnetic disk, a magnetic tape, an optical disk, a magneto-optical disk, computer RAM, and non-volatile RAM.

9. A method of moving a flexible dynamic system from an initial position to a final position according to claim 6, wherein said flexible dynamic system is selected from a group consisting of a disk drive arm and a robot arm.

10. A method of moving a flexible dynamic system from an initial position to a final position according to claim 6, wherein said velocity profile function is selected from a group consisting of a Gaussian function and a prolate spheroid function.

11. A method of moving a flexible dynamic system from an initial position to a final position according to claim 3, wherein said velocity profile function is a Gaussian function h,(t) of the form,
$${h}_{n} ( t ) = {ⅇ}^{- \frac{1}{2} {2}^{2 n} {t}^{2}}$$
wherein n is a parameter associated with said Gaussian function, and t is a variable representing time.

12. A method of moving a flexible dynamic system from an initial position to a final position according to claim 11 wherein step (e) comprises the step of
(e1) using at least said selected move time to determine said parameter n such that a near maximum spectral energy in said velocity profile function is contained within frequencies less than said smallest resonance frequency, parameter n begin determined by at least approximately maximizing a variable J with respect to n, where J is defined to be:
$$J = \frac{{\int }_{0}^{{ω}_{0}} {\vert {G}_{h , n} ( ω ) \vert}^{2} ⅆ ω}{{\int }_{0}^{π} {\vert {G}_{h , n} ( ω ) \vert}^{2} ⅆ ω}$$
wherein ω₀ is said smallest resonance frequency, and G_{h,n}(ω) is a Fourier transform of a time shifted version of hₙ(t),
$${g}_{h , n} ( t ) = \{ \begin{matrix}{h}_{n} ( t - D ) & if 0 \leq t \leq 2 D ; \\ 0 , & otherwise .\end{matrix}$$
and D is one half of said move time.

13. A method comprising
a step of providing a velocity control profile to describe a near time and frequency-optimal velocity profile for a control object during movement of the control object from an initial position to a final position during a predetermined move time, said control object having at least one resonance frequency,
the velocity profile comprising,
a functional form defined by at least one parameter, said at least one parameter being chosen to at least approximately maximize an amount of spectral energy in said velocity profile function contained within frequencies less than a smallest one of said at least one resonance frequencies based on said move time.

14. The method of claim 13, further comprising a step of moving the control object from the initial position to the final position in accordance with said velocity control profile.

15. The method of claim 13, further comprising a step of deriving from said velocity profile at least a selected one of a control voltage profile, a current profile, an acceleration profile and a displacement profile to describe an associated characteristic trajectory for the control object move from the initial position to the final position.

16. The method of claim 13, further comprising a step of utilizing the at least a selected one of said control voltage profile, current profile, acceleration profile and displacement profile to move the control object from the initial position to the final position.

17. A method of moving a flexible dynamic system from an initial position to a final position according to claim 13, wherein said control object is selected from a group consisting of a disk drive arm and a robot arm.

18. A method of moving a flexible dynamic system from an initial position to a final position according to claim 13, wherein said velocity profile functional form is selected from a group consisting of a Gaussian functional form and a prolate spheroid functional form.

19. A method of moving a flexible dynamic system from an initial position to a final position according to claim 13, wherein said velocity profile functional form is a Gaussian function hₙ(t) of the form,
$${h}_{n} ( t ) = {ⅇ}^{- \frac{1}{2} {2}^{2 n} {t}^{2}}$$
wherein n is a parameter defining said Gaussian function, and t is a variable representing time.

20. A method of moving a flexible dynamic system from an initial position to a final position according to claim 16, wherein said parameter n is chosen by at least approximately maximizing a variable J with respect to n, where J is defined to be:
$$J = \frac{{\int }_{0}^{{ω}_{0}} {\vert {G}_{h , n} ( ω ) \vert}^{2} ⅆ ω}{{\int }_{0}^{π} {\vert {G}_{h , n} ( ω ) \vert}^{2} ⅆ ω}$$
wherein ω₀ is said smallest resonance frequency, and G_{h,n}(ω) is a Fourier transform of a time shifted version of hₙ(t),
$${g}_{h , n} ( t ) = \{ \begin{matrix}{h}_{n} ( t - D ) & if 0 \leq t \leq 2 D ; \\ 0 , & otherwise .\end{matrix}$$
and D is one half of said move time.
